(19) United States
(12) Patent Application Publication
(10) Pub. No.: US 2021/0390850 A1
(43) Pub. Date: Dec. 16, 2021

(54) TRAFFIC CONDITION DETECTION METHOD

(71) Applicants: Inventec (Pudong) Technology Corporation, Shanghai (CN); INVENTEC CORPORATION, Taipei (TW)

(72) Inventors: You-Gang Chen, Taipei (TW); Jiun-Kuei Jung, Taipei (TW)

(21) Appl. No.: 17/014,141

(22) Filed: Sep. 8, 2020

(30) Foreign Application Priority Data
Jun. 16, 2020 (CN) 202010550091.1

(51) Int. Cl. G08G 1/01

(52) U.S. Cl. CPC G08G 1/0129

(57) ABSTRACT

A traffic condition detection method comprises: obtaining a plurality of traffic parameters associated with a monitoring area and obtaining a normal parameter range based on the traffic parameters, wherein at least half of the traffic parameters fall within the normal parameter range; and performing a monitoring procedure on the monitoring area, wherein the monitoring procedure comprises: determining whether a real-time traffic parameter falls within the normal parameter range; and outputting a traffic abnormality notification associated with the monitoring area when the real-time traffic parameter does not fall within the normal parameter range.

### CROSS-REFERENCE TO RELATED APPLICATIONS

This non-provisional application claims priority under 35 U.S.C. § 119(a) on Patent Application No(s). 202010550091.1 filed in China on Jun. 16, 2020, the entire contents of which are hereby incorporated by reference.

### BACKGROUND

### 1. Technical Field

This disclosure relates to a traffic condition detection method, especially to a traffic condition detection method that applies different monitoring standards to different monitoring areas.

### 2. Related Art

As traffic fields are getting more and more complicated, in order to monitor each traffic field more efficiently, many manufacturers started to develop various systems for monitoring the traffic fields. For example, existing monitoring methods include first selecting a region of interest (ROI) on the monitoring screen, and then tracking vehicles, motorcycles, and other objects in the region of interest to output traffic parameters (for example, travel speed, direction of travel, traffic flow, etc.) of the objects. Monitoring personnel in the traffic monitoring center can determine whether there are abnormal traffic conditions based on the traffic parameters.

However, the existing monitoring methods still rely on the monitoring personnel to interpret the traffic parameters to determine whether there are abnormal traffic conditions. In addition, although system can interpret simpler traffic parameters based on the already-set standard values of some basic traffic parameters, the standard values still vary with different streets and locations. Therefore, the standard values still need to be set manually, which not only still consumes manpower to finish the above-mentioned work in an early stage of the installation of monitoring system and the subsequent actual monitoring process, the monitoring results in the early stage of the installation and during the monitoring process may not still be accurate due to human errors.

### SUMMARY

Accordingly, this disclosure provides a traffic condition detection method to solve the abovementioned problems.

According to one or more embodiment of this disclosure, a traffic condition detection method, comprising: obtaining a plurality of traffic parameters associated with a monitoring area and obtaining a normal parameter range based on the traffic parameters, wherein at least half of the traffic parameters fall within the normal parameter range; and performing a monitoring procedure on the monitoring area, wherein the monitoring procedure comprises: determining whether a real-time traffic parameter falls within the normal parameter range; and outputting a traffic abnormality notification associated with the monitoring area when the real-time traffic parameter does not fall within the normal parameter range.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flow chart of a traffic condition detection method according to one embodiment of the present disclosure;

FIG. 2 is a flow chart of obtaining a plurality of traffic parameters according to one embodiment of the present disclosure;

FIG. 3A is a flow chart of obtaining a normal parameter range according to one embodiment of the present disclosure;

FIG. 3B is an exemplary diagram of the normal distribution model according to FIG. 3A;

FIG. 4A is a flow chart of obtaining a plurality of traffic parameters according to another embodiment of the present disclosure;

FIG. 4B is an exemplary diagram of the distribution status according to FIG. 4A; and

FIGS. 5A and 5B are flow charts of monitoring procedures according one or more embodiments of the present disclosure.

### DETAILED DESCRIPTION

The traffic condition detection method of the present disclosure is performed by, for example, a central processor, a server, or any other computing device of a traffic monitoring center. For better understanding of the present disclosure, the following uses a server as a device that performs the traffic condition detection method, the present disclosure is not limit thereto.

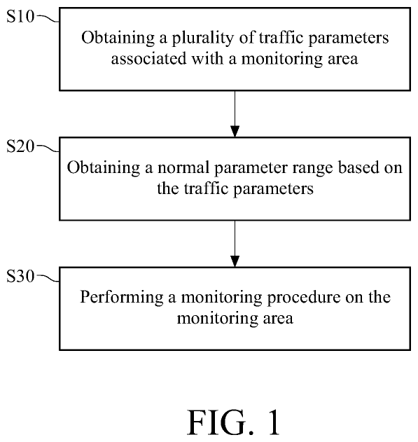

Please refer to FIG. 1, FIG. 1 is a flow chart of the traffic condition detection method according to one embodiment of the present disclosure.

Step S10: obtaining a plurality of traffic parameters associated with a monitoring area.

The traffic parameters are obtained, for example, based on the sensing data sensed by a traffic condition sensor, wherein the traffic condition sensor is, for example, a camera or a speed-measuring device. For example, when the traffic condition sensor is a camera, the monitoring area can be an entire area within the shooting range of the camera, or a partial area within the shooting range of the camera (for example, a street, a parking space, a side walk or a part of a street, etc.). Therefore, the sensing data sensed by the traffic condition sensor are, for example, images taken by the camera.

The server is in communication connection with the traffic condition sensor to obtain sensing data such as the images. After obtaining the images, the server performs image recognition on the objects located in the monitoring area in the images, and tracks the identified objects to determine parameters such as the moving speed, moving direction, residence time in the monitoring area, a ratio between the number of objects in the monitoring area and the entire monitoring area, and the number of objects passing through the monitoring area in a period of time. The parameters can be used as the traffic parameters.

Similarly, when the traffic condition sensor is the speed-measuring device, the moving speeds of the objects sensed by the speed-measuring device can also be used as the traffic parameters, the present disclosure does not limit thereto.

Step S20: obtaining a normal parameter range based on the traffic parameters.

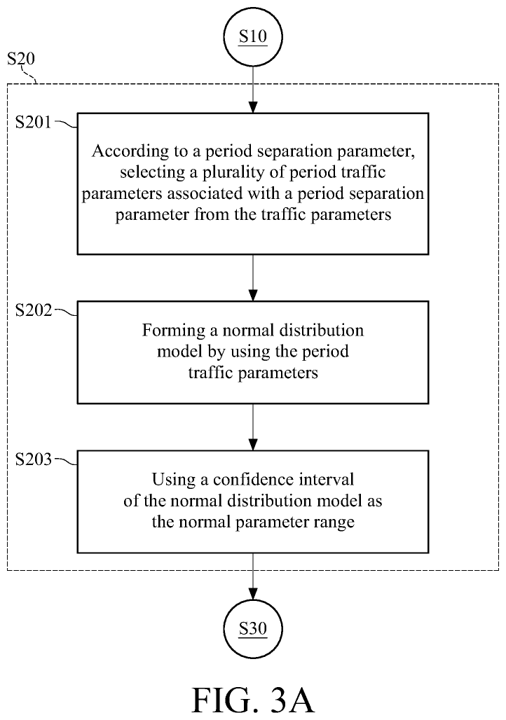

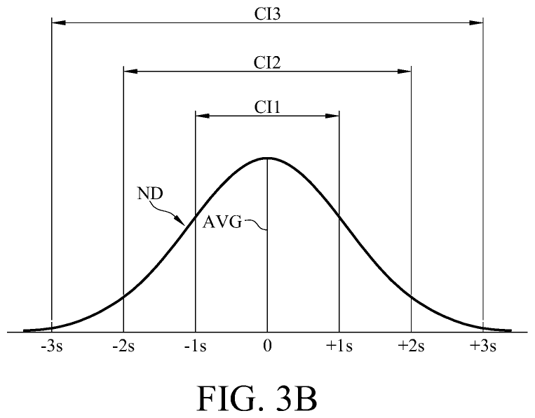

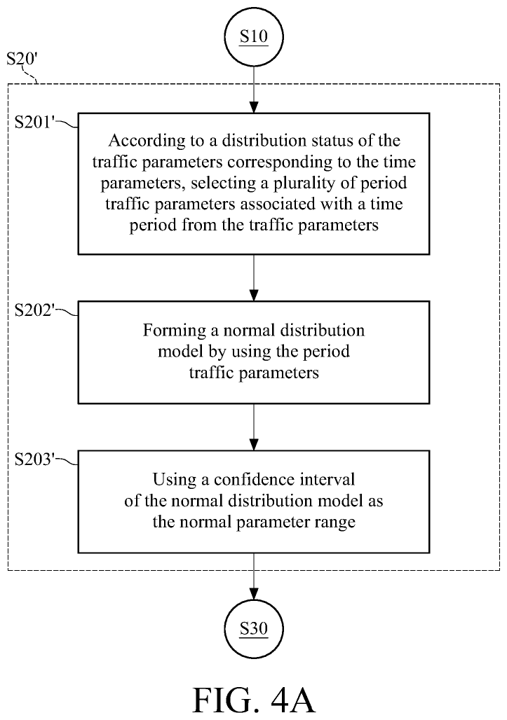

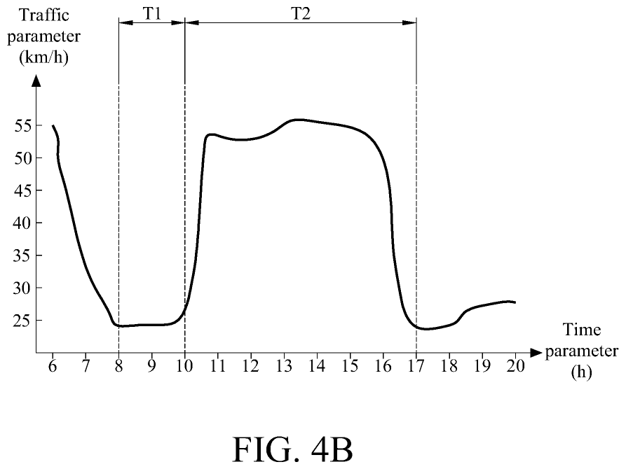

After obtaining the traffic parameters, the server can integrate at least half of the traffic parameters as a parameter range. The server can use this parameter range as the normal parameter range. In other words, at least half of the traffic parameters fall within the normal parameter range, wherein obtaining the normal parameter range based on the traffic parameters will be further described in the embodiments of FIGS. 3A and 4A.

Step S30: performing a monitoring procedure on the monitoring area.

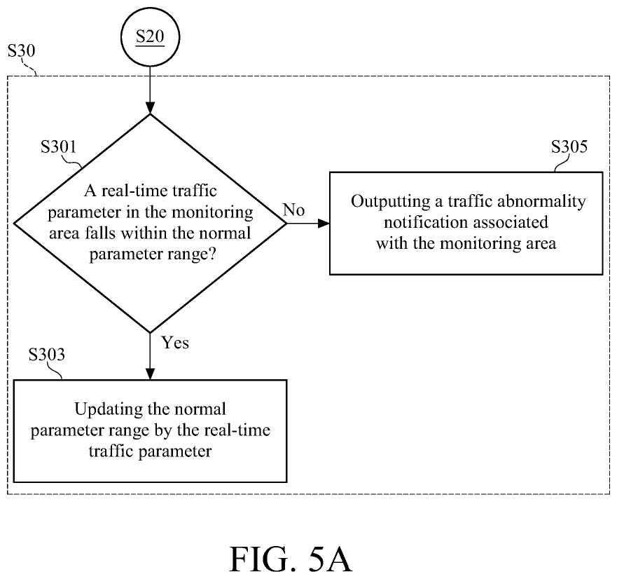

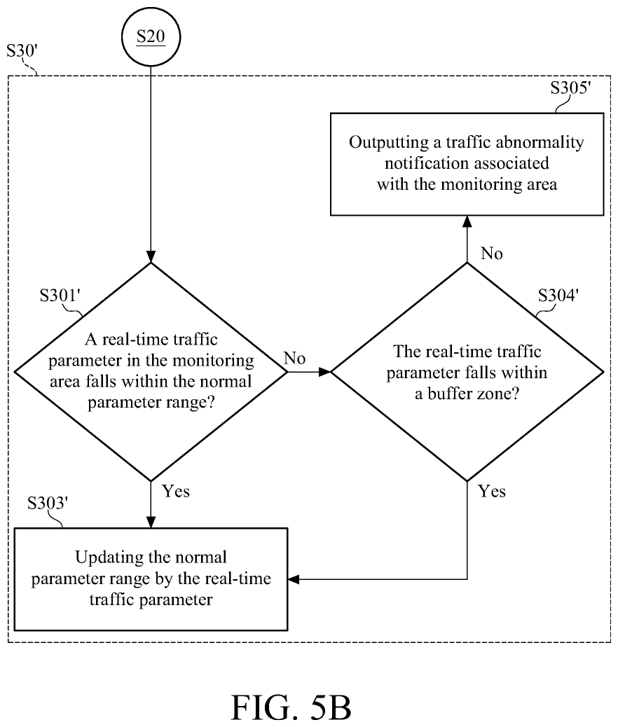

After obtaining the normal parameter range, the server can perform real-time monitoring on the objects in the monitoring area by determining whether the real-time traffic parameters corresponding to the one or more objects in the monitoring area fall within the normal parameter range, then take the corresponding measure accordingly. The monitoring procedure will be further described in the embodiments of FIG. 5.

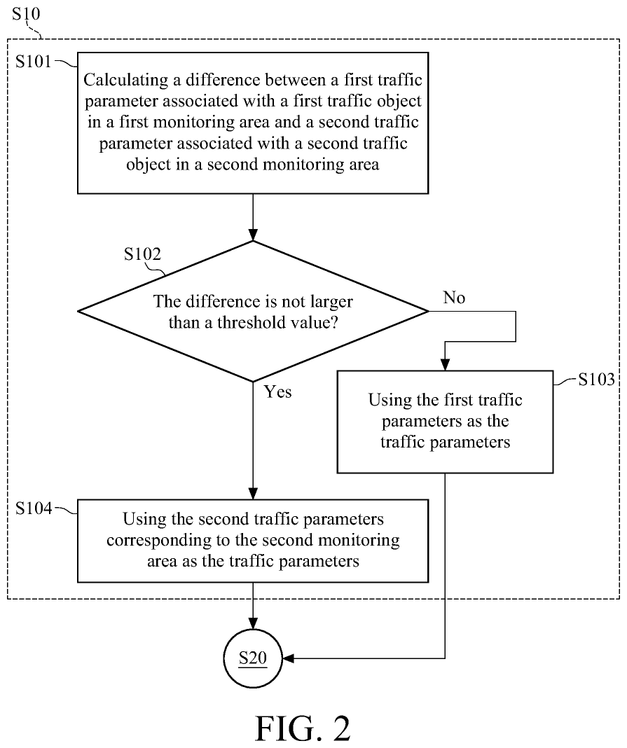

Please first refer to FIG. 2, FIG. 2 is a flow chart of obtaining a plurality of traffic parameters according to one embodiment of the present disclosure. That is, the methods of obtaining the traffic parameters shown in step S10 of FIG. 1 can not only be achieved by using the traffic condition sensor as described above, but also by the method shown in FIG. 2. Therefore, the traffic monitoring system of a traffic field can start monitoring at an early stage of installation, so as to reduce the time of collecting and analyzing multiple pieces of sensing data beforehand.

Step S101: calculating a difference between a first traffic parameter associated with a first traffic object in the first monitoring area and a second traffic parameter associated with a second traffic object in a second monitoring area.

It should be noted that, the first monitoring area and the second monitoring area are different monitoring areas. The first monitoring area is, for example, a monitoring area with a newly installed traffic condition sensor; and the second monitoring area is, for example, a monitoring area that the server has already started performing traffic monitoring procedure based on the traffic parameters obtained from the second monitoring area. A type of the first traffic object is similar to a type of the second traffic object. For example, the first and second traffic objects can both be cars, motorcycles, or pedestrians. The first and second traffic objects can also be vehicles with wheels. That is, the first and second traffic objects are preferably the same or similar types of traffic objects. However, the present disclosure does not limit the types of the first traffic object and the second traffic object.

Specifically, the implementation of the server determining the difference between the traffic conditions of the first monitoring area and the second monitoring area can be, for example, that the server obtains the first traffic parameter of the first traffic object in the first monitoring area, and the second traffic parameter of the second traffic object in the second monitoring area. Then a difference between the first traffic parameter and the second traffic parameter is calculated and used as the aforementioned difference.

For example, the first traffic object and the second traffic object are both cars; the first traffic parameter is a speed of 80 km/h, and the second traffic parameter is a speed of 85 km/h. The server can subtract the first traffic parameter of 80 km/h from the second traffic parameter of 85 km/h to obtain a difference of 5 km/h. Obtaining the difference by subtraction is merely an example. The difference can also be obtained by dividing the subtraction value of the two traffic parameters by the first or second traffic parameter, or even by a more complicated calculation equation. The present disclosure does not limit the forms of the difference.

It should be noted that, the aforementioned speed uses a single first traffic parameter and a single second traffic parameter as an example, the number of second traffic parameters acquired by the server is preferably larger than the number of the first traffic parameters. The difference is therefore preferably calculated based on a set of the first traffic parameters and a set of the second traffic parameters (such as an average of multiple first traffic parameters and an average of multiple second traffic parameters).

Step S102: determining whether the difference is not larger than a threshold value.

After the difference is calculated, the server can determine whether the difference between the first traffic parameter of the first monitoring area and the second traffic parameter of the second monitoring area is not larger than the threshold value, wherein the threshold value is used to represent an allowable difference between the two traffic parameters.

Step S103: using the first traffic parameters as the traffic parameters.

When the difference is larger than the threshold value, it means the difference of traffic condition between the first monitoring area and the second monitoring is too high (the similarity is low). Therefore, the server does not refer to the second traffic parameters of the second monitoring area. Instead, the server uses the first traffic parameters obtained by using the traffic condition sensor installed in the first monitoring area as the traffic parameters. The server then performs step S20 as shown in FIG. 1 after obtaining the traffic parameters.

Step S104: using the second traffic parameters corresponding to the second monitoring area as the traffic parameters.

In other words, when the difference is not larger than the threshold value, it means the traffic condition of the second monitoring area is similar to the traffic condition of the first monitoring area. Therefore, in a situation where the amount of the first traffic parameters of the first monitoring area are still insufficient, the server can use the accumulated second traffic parameters of the second monitoring area as the traffic parameters. The server then performs step S20 as shown in FIG. 1 after obtaining the traffic parameters.

In view of the above description, the methods of obtaining the traffic parameters shown in FIG. 2 can be used in the first monitoring area with a newly installed traffic condition sensor. Therefore, even the obtained first traffic parameters are still insufficient for obtaining the normal parameter range in the subsequent step S20, or insufficient for obtaining the normal parameter range of valuable reference, it is still possible to use the second traffic parameters of the second monitoring area with similar traffic condition as traffic parameters for forming the normal parameter range of the first monitoring area, so that the server can perform the monitoring procedure on the first monitoring area as soon as possible, thereby reducing the time from collecting a sufficient amount of the first parameters to obtaining the normal parameter range corresponding to the first monitoring area. In addition, by first evaluating the difference between the first traffic parameters and the second traffic parameters, it is possible to effectively reduce errors of performing the monitoring procedure when applying the second traffic parameters or the normal parameter range of the second monitoring area to the first monitoring area.

Please first refer to FIG. 3A, FIG. 3A is a flow chart of obtaining a normal parameter range according to one embodiment of the present disclosure. That is, FIG. 3A is one of the methods of implementing step S20 of FIG. 1.

Step S201: according to a period separation parameter, selecting a plurality of period traffic parameters associated with a period separation parameter from the traffic parameters.

The period separation parameter is configured to divide parameters of different time period, so as to select traffic parameters corresponding to different time period. For example, the period separation parameters are 8 a.m. and 10 a.m. in the morning, the server can filter out the traffic parameters obtained between 8 a.m. and 10 a.m. from the traffic parameters according to the period separation parameters, and use the traffic parameters that fall between 8 a.m. and 10 a.m. as the plurality of period traffic parameters.

Step S202: forming a normal distribution model by using the period traffic parameters.

The server can divide the time period between 8 a.m. and 10 a.m. into multiple sub-periods, and establish a histogram with the traffic parameters corresponding to the sub-periods. The server then connects the midpoints of the top edge of each square in the histogram with a straight line or a curve to form a normal distribution model. The normal distribution model is a model composed of traffic parameters within 8 a.m. and 10 a.m.

Step S203: using a confidence interval of the normal distribution model as the normal parameter range.

Please refer to FIG. 3B as well, FIG. 3B is an exemplary diagram of the normal distribution model ND according to FIG. 3A, wherein a horizontal axis of the normal distribution model ND is, for example, the distribution range of the period traffic parameters in a period of time; a vertical axis of the normal distribution model ND is, for example, a cumulative number of objects in each period traffic parameter interval. For example, when the traffic parameter is car speed, then the horizontal axis of the normal distribution model ND can be the distribution range of the speeds obtained between 8 a.m. and 10 a.m. (for example, from speed of 15 km/h to speed of 40 km/h); and the vertical axis of the normal distribution model ND can be the cumulative number of cars whose speed falls in each speed interval (for example, the cumulative number of cars whose speeds fall in the speed 15 km/h to 20 km/h interval, the cumulative number of cars whose speeds fall in the speed 20 km/h to 25 km/h interval and so on).

After forming the normal distribution model ND as shown in FIG. 3B, the server can use the confidence intervals CI1 to CI3 of the normal distribution model ND as the normal parameter range, wherein the confidence intervals CI1 to CI3 are, for example, the speed interval of an average AVG of the period traffic parameters plus or minus one or more standard deviations S. To better understand that the average AVG is a value that is not added with or subtracted by the standard deviation S, the average AVG shown in FIG. 3B is represented as the value “0”, the present disclosure does not limit the actual value of the average AVG. In other words, the normal parameter range is, for example, a 68% confidence interval CH with the average AVG plus and minus three standard deviations S (+3S and −3S), a 95% confidence interval CI2 with the average AVG plus and minus two standard deviations S (+2S and −2S), or a 99.7% confidence interval CI3 with the average AVG plus and minus one standard deviation S (+1S and −1S). The present disclosure does not limit the value of the confidence interval.

Please refer to FIG. 4A, FIG. 4A is a flow chart of obtaining a plurality of traffic parameters according to another embodiment of the present disclosure. That is, FIG. 4A is one of the methods of implementing step S20 of FIG. 1.

Step S201′: according to a distribution status of the traffic parameters corresponding to the time parameters, selecting a plurality of period traffic parameters associated with a time period from the traffic parameters.

In other words, while obtaining the traffic parameters, the server also records the time parameter corresponding to each traffic parameter (the time when each traffic parameter is sensed). Therefore, the server can first establish the distribution status of the traffic parameters corresponding to the time parameters.

Please also refer to FIG. 4B, FIG. 4B is an exemplary diagram of a distribution status according to FIG. 4A. Take FIG. 4B for example, the unit of the time parameter is “hour”, and the unit of the traffic parameter is “km/h”. That is, a horizontal axis of the distribution status ranges, for example, from 6 a.m. to 20 p.m.; and a vertical axis of the distribution status ranges, for example, from 25 km/h to 55 km/h.

The server can determine the traffic condition from 8 a.m. to 10 a.m. is different from the traffic condition from 10 a.m. to 17 p.m. by a change of slope of each moment or time period according to the distribution status as shown in FIG. 4B. Therefore, the server can further select a plurality of period traffic parameters corresponding to the 8 a.m. to 10 a.m. time period T1, and a plurality of period traffic parameters corresponding to the 10 a.m. to 17 p.m. time period T2.

Please refer to step S202′ of FIG. 4A. Step S202′: forming the normal distribution model by using the period traffic parameters; and step S203′: using a confidence interval of the normal distribution model as the normal parameter range.

After filtering out the period traffic parameters corresponding to different time periods, the server can perform steps S202′ and S203′ to obtain the normal parameter range, wherein the implementation of steps S202′ and S203′ are the same as the steps S202 and S203 of FIG. 3A. Thus, the details of steps S202′ and S203′ are not further described herein.

In addition, similar to the embodiment of FIG. 2, when the traffic condition sensor in the first monitoring area is in the early stage of installation and the number of the first traffic parameters is still insufficient to establish the normal parameter range of valuable reference, the server can also perform steps S101 to S102 as shown in FIG. 2, and use the normal parameter range of the second monitoring area as the normal parameter range of the first monitoring area when the difference is not larger than the threshold value.

Please refer to FIG. 5A, FIG. 5A is a flow chart of a monitoring procedure according one embodiment of the present disclosure. That is, FIG. 5A is one of the methods of implementing step S30 of FIG. 1.

Step S301: determining whether a real-time traffic parameter in the monitoring area falls within the normal parameter range.

After performing real-time sensing by the traffic condition sensor on the objects in the monitoring area to obtain the real-time traffic parameters, the server can then determine whether the real-time traffic parameters fall within the normal parameter range. For example, the monitoring area can be an area in front of a traffic light at an intersection; the normal parameter range can be an average residence time of the vehicles when the traffic light presents a red light, wherein the normal parameter range can be 40 to 60 seconds; and the real-time traffic parameter can be the actual residence time of the sensed object in front of the traffic light when the traffic light presents the red light.

Step S303: updating the normal parameter range by the real-time traffic parameter.

When the server determines the real-time traffic parameter falls within the normal parameter range, it means the condition of the object in the monitoring area fits a normal condition of the monitoring area. The server can update the normal parameter range by the real-time traffic parameter.

Take the residence time in front of the traffic light described above for example, when the server determines a real-time traffic parameter of 55 seconds falls within the normal parameter range of 40 to 60 seconds in step S301, the server can update the normal parameter range with the real-time traffic parameter of 55 seconds. In this case, a median value and/or an average value of the normal parameter range increases slightly, and when the ratio of the confidence interval is not changed, the boundary value, which is 40 seconds, of the normal parameter range also increases after the update. In this way, the normal parameter range is continuously maintained in accordance with the current traffic condition of the monitoring area.

Besides, the server can update the normal parameter range based on the real-time traffic parameter by using Bayesian Inference theorem to predict the range of the normal parameter range. It should be noted that, Bayesian Inference theorem can be used to train artificial neural network (ANN) for the server to predict a more accurate value/range. Bayesian Inference theorem described here is merely an example, the server can also use other theorem such as Frequentist Inference theorem, Likelihood-based Inference theorem, Akaike information criterion theorem, etc. and its branching methods to predict the normal parameter range. The present disclosure does not limit the methods of predicting the normal parameter range.

Use the occupancy ratio of the vehicles in the monitoring area as the traffic parameter as an example, the equation for predicting the normal parameter range of the corresponding occupancy ratio can be as follows:

$$f ( p \vert x ) = \frac{f ( x \vert p )}{{f}_{x} ( x )} π ( p )$$

wherein, x is the sum of the time the vehicles are actually detected in the monitoring area; p is the assumed occupancy ratio of the vehicles in the monitoring area. And as shown in the embodiment of FIG. 2, p can also be the occupancy ratio assumed based on the occupancy ratio of other similar monitoring areas. In other words, f(p|x) is the probability of p being true with given x; f(x|p) is the probability of observing x when p is true (i.e., the probability of x being true with assumed p); fₓ(x) is a sum of the time (x) that vehicles actually exist in the monitoring area corresponds to a total time of detection (that is, if the total time of detection is n, then fₓ(x) is x/n); and π(p) is the probability of p being true before x is observed (that is, the probability of p being true without considering x).

Therefore, after obtaining x and p, the server can first calculate f(x|p), fₓ(x), and π(p), then calculate f(p|x) by using the formula shown above, wherein f(p|x) is the normal parameter range corresponding to the occupancy ratio predicted by the server. Therefore, after calculating f(p|x), the server can further determine whether f(p|x) is larger than a default value, and use p as the occupancy ratio of vehicles of the monitoring area when f(p|x) is larger than the default value; and perform another prediction by using another assumed p when f(p|x) is smaller than the default value.

Step S305: outputting a traffic abnormality notification associated with the monitoring area.

That is, when the server determines the real-time traffic parameter falls outside of the normal parameter range in step S301, it means the condition of the objects in the monitoring area does not fit the normal condition of the monitoring area. The server then can output the traffic abnormality notification, wherein the traffic abnormality notification preferably includes a location information of the monitoring area.

Take the residence time in front of the traffic light described above for example, when the server determines a real-time traffic parameter of 70 seconds falls outside of the normal parameter range of 40 to 60 seconds in step S301, it means there might be abnormal events such as vehicle breakdown or accident near the traffic light. Therefore, the server can output the traffic abnormality notification to a terminal device of the traffic monitoring center, wherein the traffic abnormality notification preferably includes the location information of the traffic light (monitoring area) and the residence time (real-time traffic parameter) of the object in front of the traffic light, so as to notify the monitoring personnel there might be some abnormal events that need to be processed.

In addition, after determining the real-time traffic parameter falls within the normal parameter range (step S301), and before updating the normal parameter range by the real-time traffic parameter (step S305), the server can multiply the real-time traffic parameter by a weight value larger than 1, then update the normal parameter range by the multiplied real-time traffic parameter. Therefore, the updated normal parameter range can be more in accordance with the current traffic condition.

Please refer to FIG. 5B, FIG. 5B is a flow chart of a monitoring procedure according one embodiment of the present disclosure (step S30′), wherein steps S301′, S303′ and S305′ of FIG. 5B are the same as steps S301, S303 and S305 of FIG. 5A. Thus, the details of steps S301′, S303′ and S305′ are not further described herein. The difference between FIG. 5B and FIG. 5A lies in that, when determining the real-time traffic parameter does not fall within the normal parameter range in step S301′, the server performs step S304′.

Step S304′: determining whether the real-time traffic parameter falls within a buffer zone.

There can be a buffer zone outside of the normal parameter range, and the buffer zone is adjacent to the boundary of the normal parameter range. In other words, when the server determines the real-time traffic parameter does not fall within the normal parameter range in step S301′, the server can further perform step S304′ to determine whether the real-time traffic parameter falls within the buffer zone.

Take the residence time in front of the traffic light described above for example, the boundaries of the normal parameter range are 40 seconds and 60 seconds. The buffer zone corresponding to the 40 seconds boundary can be, for example, 35 to 40 seconds; and the buffer zone corresponding to the 60 seconds boundary can be, for example, 60 to 65 seconds. Therefore, when the server determines a real-time traffic parameter of 63 seconds falls within the 60 to 65 seconds buffer zone, the server can perform step S303′. On the contrary, when the server determines a real-time traffic parameter of 30 seconds does not fall within the 35 to 40 seconds buffer zone, the server can perform step S305′. That is, the server can further determine whether a real-time traffic parameter falls within one of the two buffer zones when the real-time traffic parameter does not fall within the normal parameter range.

In short, when the real-time traffic parameter does not fall within the normal parameter range, the server can perform S305 to output the traffic abnormality notification as shown in FIG. 5A, the server can also first perform step S304′ to determine whether the real-time traffic parameter falls within the buffer zone as shown in FIG. 5B, and then choose to perform step S303′ or step S305′ based on the result of step S304′, thereby avoid the traffic monitoring center constantly receiving the traffic abnormality notification and avoid the increase of workload for monitoring personnel.

In view of the above description, according to one or more embodiments of the traffic condition detection method of the present disclosure, proper normal parameter ranges may be established for different monitoring areas to apply different monitoring standards on different monitoring areas and different time periods (for example, peak time period, off-peak time period). Further, when the environment of the monitoring area changes, the normal parameter range may be updated with proper traffic parameter, to maintain the normal parameter range in accordance with a current condition of the monitoring area. In addition, it is possible to perform the monitoring procedure on monitoring area with a newly installed traffic condition sensor. Besides, when it is determined that an abnormal event occurs in the monitoring area, monitoring personnel can be notified immediately so as to take proper measures, and at the same time, it is possible to avoid inaccurate monitoring results caused by artificially determining whether the traffic parameter is abnormal.

The present disclosure has been disclosed above in the embodiments described above, however it is not intended to limit the present disclosure. It is within the scope of the present disclosure to be modified without deviating from the essence and scope of it. It is intended that the scope of the present disclosure is defined by the following claims and their equivalents.

What is claimed is:

1. A traffic condition detection method, comprising:
obtaining a plurality of traffic parameters associated with a monitoring area, and obtaining a normal parameter range based on the traffic parameters, wherein at least half of the traffic parameters fall within the normal parameter range; and
performing a monitoring procedure on the monitoring area, wherein the monitoring procedure comprises:
determining whether a real-time traffic parameter falls within the normal parameter range; and
outputting a traffic abnormality notification associated with the monitoring area when the real-time traffic parameter does not fall within the normal parameter range.

2. The detection method according to claim 1, wherein when the real-time traffic parameter falls within the normal parameter range, the monitoring procedure further comprises:
updating the normal parameter range by the real-time traffic parameter.

3. The detection method according to claim 2, wherein there is a buffer zone outside of the normal parameter range, and the buffer zone is adjacent to a boundary of the normal parameter range, when the real-time traffic parameter does not fall within the normal parameter range, the monitoring procedure further comprising:
determining whether the real-time traffic parameter falls within the buffer zone; and
updating the normal parameter range by the real-time traffic parameter when the real-time traffic parameter falls within the buffer zone.

4. The detection method according to claim 2, wherein after determining the real-time traffic parameter falls within the normal parameter range, and before updating the normal parameter range by the real-time traffic parameter, the monitoring procedure further comprises:
multiplying the real-time traffic parameter by a weight value larger than 1.

5. The detection method according to claim 1, wherein the monitoring area is a first monitoring area, obtaining the traffic parameters associated with the monitoring area comprising:
calculating a difference between a first traffic parameter and a second traffic parameter, wherein the first traffic parameter is associated with a first traffic object in the first monitoring area, and the second traffic parameter is associated with a second traffic object in a second monitoring area, and a type of the first traffic object is similar to a type of the second traffic object;
determining whether the difference is not larger than a threshold value; and
using the accumulated second traffic parameters corresponding to the second monitoring area as the traffic parameters when the difference is not larger than the threshold value.

6. The detection method according to claim 1, wherein obtaining the normal parameter range based on the traffic parameters comprises:
forming a normal distribution model by the traffic parameters; and
using a confidence interval of the normal distribution model as the normal parameter range.

7. The detection method according to claim 1, wherein obtaining the normal parameter range based on the traffic parameters comprises:
according to a period separation parameter, selecting a plurality of period traffic parameters associated with the period separation parameter from the traffic parameters;
forming a normal distribution model by using the period traffic parameters; and
using a confidence interval of the normal distribution model as the normal parameter range.

8. The detection method according to claim 1, wherein while obtaining the traffic parameters, the detection method further comprises: recording a time parameter corresponding to each traffic parameter, and wherein obtaining the normal parameter range based on the traffic parameters comprises:
according to a distribution status of the traffic parameters corresponding to the time parameters, selecting a plurality of period traffic parameters associated with a time period from the traffic parameters;
forming a normal distribution model by using the period traffic parameters; and
using a confidence interval of the normal distribution model as the normal parameter range.

9. The detection method according to claim 1, wherein the traffic abnormality notification comprises a location information of the monitoring area.

10. The detection method according to claim 2, wherein updating the normal parameter range by the real-time traffic parameter comprises:
updating the normal parameter range based on the real-time traffic parameter using Bayesian Inference theorem.
